(19) United States
(12) Patent Application Publication
(10) Pub. No.: US 2024/0096550 A1
(43) Pub. Date: Mar. 21, 2024

(54) High-compactness bonded rare earth permanent magnet and preparation method thereof

(71) Applicant: Chengdu To-Nan Electronics Co., Ltd., Chengdu (CN)

(72) Inventor: Chuanlong CHEN, Chengdu (CN)

(21) Appl. No.: 18/172,811

(22) Filed: Feb. 22, 2023

(30) Foreign Application Priority Data
Sep. 16, 2022 (CN) 202211125499.X

(51) Int. Cl. H01F 41/02; H01F 1/08

(52) U.S. Cl. CPC H01F 41/0266; H01F 1/08

(57) ABSTRACT

A high-compactness bonded rare earth permanent magnet and a preparation method thereof. Raw materials of the rare earth permanent magnet are calculated by mass percentage and include a thermosetting resin, a lubricant, a coupling agent, and the balance being a rare earth permanent magnetic powder. The preparation method includes: mixing the rare earth permanent magnetic powder with an organic solution containing the thermosetting resin to obtain a magnetic powder complex, mixing the magnetic powder complex with the lubricant, filling into a mold and compressing and molding at 12-50 T/cm² for 0.3-10 s, demolding to obtain a green body, heating the green body at 120-200° C. and obtaining a rough blank for precision machining. The high-compactness bonded rare earth permanent magnet shortens distances among micro powder particles in the bonded magnet effectively, enhances the magnetization effect of micro powder and strengthens the interaction force thereof after magnetization.

### TECHNICAL FIELD

The present invention belongs to the technical field of permanent magnets, in particular to a high-compactness bonded rare earth permanent magnet and a preparation method thereof.

### BACKGROUND TECHNOLOGY

In recent years, rare earth permanent magnets represented by praseodymium/neodymium iron boron, and its lanthanum cerium substitutes, samarium cobalt, etc. have been widely used because of their extremely high magnetic properties and relative stability in fields from aerospace to wind power generation, or industries from household appliances, precision machine tools to new energy vehicles, with the increasing requirements for high gravimetric specific power and stability in the motor field, there are more and more application of rare earth permanent magnets represented by neodymium iron boron, lanthanum cerium substitutes thereof, and samarium cobalt as magnetic energy components.

Since the appearance of rare earth permanent magnets in the 1970s, the preparation technology thereof has been developed rapidly. According to different preparation processes, rare earth permanent magnets are divided into sintered rare earth permanent magnets and the bonded rare earth permanent magnets, wherein those taking organic substances like resins, plastics and rubbers to be the complexing medium (also known as binder) of rare earth permanent magnetic powder are collectively referred to as bonded rare earth permanent magnets (hereinafter referred to as bonded magnets). Bonded magnets were first invented in Japan in the 1980s, and then by virtue of different bonding media and processes, compression bonded magnets (generally suitable for resin complexing magnets), injection bonded magnets (generally using thermoplastics such as nylon, polyformaldehyde, and polyphenylene sulfide as the complexing medium) and calendering bonded magnets (generally using modified rubbers as the complexing medium) have been derived and developed successively; bonded magnets prepared through organic complexing media and compression molding do not need high temperature sintering, and avoid deformation and post-processing caused by high temperature, thereby getting characteristics of high dimensional accuracy by one-time molding and being suitable for mass production. In the 1990s, bonded magnets began to be manufactured massively, which led to the rapid development of preparation technology thereof, coupled with the tremendous progress made in information technology since the late 1990s, bonded rare earth permanent magnets have been widely applied in computer storage drives, computer peripherals, vehicle precision control, configuration of comfort in vehicle and other fields.

Although mass production of bonded rare earth magnets has been achieved, the demand thereof grows slowly after the global consumption reached 6000 tons in 2010. In comparison to the global development of sintered rare earth permanent magnets, it still has been an arduous task for the bonded rare earth permanent magnets to step into the mainstream of global permanent magnet materials. Up to now, the current global stock market scale of sintered rare earth permanent magnets has reached more than 200,000 tons per year, while the amount of bonded rare earth permanent magnets is only 10,000 tons per year, and gradually degrades from less than one tenth of the sintered market in 2010 to less than one twentieth of sintered rare earth permanent magnets in 2021.

The rapid and steady increase of shipments of sintered praseodymium/neodymium iron boron magnets in recent years indicates that the demand for application of rare earth permanent magnets represented by high performance and high gravimetric specific power is increasing rapidly. However, the bonded rare earth permanent magnets fail to meet the demand. Take the most commonly used neodymium magnets as an example, the measured value of BHₘₐₓ of isotropic compression bonded neodymium magnets with the highest performance in mass production is up to about 12 MGOe, the measured value of BHₘₐₓ is about 20 MGOe under the orientation condition of anisotropic molded HDDR magnets with the highest performance in mass production, the measured value of that of sintered neodymium magnets with the highest performance in mass production can reach about 52 MGOe after orientation under a good crystallization condition, and the huge difference in magnetic properties makes it difficult to apply bonded neodymium in occasions that require higher performance.

In addition, with regard to material utilization and costs, when the sintered neodymium magnets containing 21% neodymium are compared with the compression bonded praseodymium and/or neodymium magnetic powder prepared by the rapid quenching method with the same neodymium content, the measured BHₘₐₓ of the sintered neodymium magnets under non-orientation conditions can reach about 24 MGOe, while the measured BHₘₐₓ of the bonded magnets can only reach about 9 MGOe. It is concluded that in performance application, the actual cost performance of bonded rare earth permanent magnets is much lower than that of sintered magnets with the same rare earth content; in other words, the poor utilization of rare earths becomes a bottleneck restricting the application expansion of bonded rare earth permanent magnets, and the above is a good illustration of the difficulties confronted by the development of bonded rare earth permanent magnets in recent years.

### SUMMARY OF THE INVENTION

In order to solve the above technical problems, the present invention provides a method for preparing a high-compactness bonded rare earth permanent magnet.

The present invention is implemented through following technical solutions:
On a first aspect, the present invention disclose a method for preparing high-compactness bonded rare earth permanent magnet, raw materials of the high-compactness bonded rare earth permanent magnet calculated by a mass percentage comprise: thermosetting resin 0.1-1.6 wt %, a lubricant 0.05-0.8 wt %, a coupling agent 0-1.0 wt %, and the balance being rare earth permanent magnetic powder; and
the method comprises:
mixing the rare earth permanent magnetic powder after crystallization treatment with a solution in which the thermosetting resin and the coupling agent are dissolved to obtain a mixture, drying the mixture after sealing and stirring, and obtaining a magnetic powder complex after crushing;
mixing the magnetic powder complex with the lubricant to obtain clinker; and
filling the clinker into a mold at a temperature of 40-120° C. for preheating, after compressing and molding, demolding to obtain a green body, heating the green body at 120-200° C. for 2-3 h to obtain a rough blank, and conducting precision machining on the rough blank.

Further, the rare earth permanent magnetic powder comprises at least one of rapidly quenched praseodymium and/or neodymium iron boron magnetic powder and modified powder thereof containing dysprosium/terbium/cobalt/aluminum, rapidly quenched lanthanum iron boron powder, rapidly quenched cerium iron boron powder, HDDR permanent magnetic powder, samarium cobalt permanent magnetic powder, permanent magnet ferrite powder, samarium iron nitrogen permanent magnetic powder and neodymium-containing Fe₃B-based permanent magnet alloy powder.

Further, in a preferable embodiment of the present invention, the coupling agent comprises at least one or a mixture of silane and/or titanate.

Further, in a preferable embodiment of the present invention, the lubricant comprises graphite and/or stearic acid and stearate; and

preferably, the stearate comprises zinc stearate and/or calcium stearate.

Further, in a preferable embodiment of the present invention, the crystallization treatment takes place in a high-purity argon atmosphere at 670-730° C. for 10-20 min.

Further, in a preferable embodiment of the present invention, the rare earth permanent magnetic powder after the crystallization treatment has a particle size of 60-200 mesh.

Further, in a preferable embodiment of the present invention, sealing and stirring takes 40-60 min for preparing the magnetic powder complex.

Further, in a preferable embodiment of the present invention, the green body has a density of 6.2-7.1 g/cm³.

Further, in a preferable embodiment of the present invention, the compressing and molding takes place at an unit compressing force of 12-50 T/cm² for 0.3-10 s.

Further, in a preferable embodiment of the present invention, in order for a further improved density of the rough blank, heating the green body to obtain the rough blank specifically comprises: heating the green body till an epoxy softening point thereof is reached, vacuumizing till a pressure of environment is less than 0.2 atmosphere, and keeping a temperature of environment at 120-200° C. for 2-3 h.

Further, in a preferable embodiment of the present invention, the method further comprises a step of painting a protective coating on a surface of the clinker after conducting precision machining; and

the protective coating is prepared in at least one of following manners: applying antirust oil, electrophoresing, spraying epoxy, plating zinc, plating nickel, plating chrome, spraying plastics and coating parylene.

On a second aspect, the present invention provides a high-compactness bonded rare earth permanent magnet prepared by the above method, the high-compactness bonded rare earth permanent magnet has a density of 6.2-7.0 g/cm³; and

preferably, the high-compactness bonded rare earth permanent magnet further comprises a protective coating, and on the protective coating comprises at least one of antirust oil, electrophoretic paint, zinc plating, nickel plating, chrome plating, plastic spraying and parylene coating.

Compared with the prior art, the present invention has at least following technical effects:
1. In the present invention, compression molding method is used to prepare the permanent magnet, so that the utilization of the bonded rare earth permanent magnetic powder is high and it is easier to display high magnetic properties to the outside. Therefore, compared with the prior art, the bonded rare earth permanent magnet prepared by the compression molding method in the present invention achieves more economic benefits and a higher resource utilization rate.
2. The bonded rare earth permanent magnet provided in the present invention has a relatively large force between domains, so that the permanent magnet as a whole exhibits higher performance to the outside.
3. Generally, for compression bonded permanent magnets in bonded magnets, in order for necessary structural strength and smooth demolding of bonded permanent magnets, it is necessary to ensure that a mass percentage of the complexing medium—thermosetting resins (hereinafter referred to as resins) is 1.8-4.0 wt %, otherwise the products will not be molded. However, the presence of resins will greatly limit further compression of distances among micro-powder particles in the microstructure of bonded permanent magnets. Take W-6C epoxy resin, the most commonly used resin as an example, since the resin density thereof is only about 1.1 g/cm², the resin complex occupies 12-30% of the magnet volume. Therefore, from the beginning of this century, the global mass production density of compression bonded neodymium magnets has been stable at 5.6-6.1. Compared with the product density of sintering bonded magnets which is above 7.2, there is a large distance, which greatly reduces the magnetization effect and interaction force after magnetization of the micro rare earth magnetic powder in the finished magnets, so that it is difficult for the bonded magnets to achieve higher performance, compared with sintered magnets with dense microstructure. And the bonded rare earth permanent magnet provided in present invention effectively shortens distances among micro powder particles in the bonded magnet by reducing the volume proportion of resin binder in the compression bonded magnet (about 1%-10%), thereby effectively promoting the magnetization effect of micro powder and increasing the interaction force after magnetization.

### SPECIFIC EMBODIMENTS

Embodiments of the present invention will be described in detail below in conjunction with the examples, but those skilled in the art will understand that the following embodiments are only used to illustrate the present invention, and should not be considered as limiting the scope of the present invention, and the specific conditions not indicated in the embodiments shall be carried out in accordance with conventional conditions or those suggested by manufacturers, and reagents or instruments used shall be conventional products which may be purchased commercially.

Specific embodiments of the present invention have following embodiments:

An embodiment of the present invention provides a method for preparing a high-compactness bonded rare earth permanent magnet, and raw materials of the high-compactness bonded rare earth permanent magnet calculated by a mass percentage comprise: thermosetting resin 0.2-1.6 wt %, a lubricant 0.05-0.8 wt %, a coupling agent 0-1.0 wt %, and the balance being rare earth permanent magnetic powder.

Usually, 1.8-4.0 wt % of binders are generally used in the prior art, but the densities of resin binder materials are much lower than the density of magnetic powder, so resin materials of high mass percentages will bring high resin volume ratios, thus affecting the magnetization effect and magnetic performance of magnetic powder particles. In order for high structural strength of a final product, the bonded rare earth permanent magnet provided in the present invention greatly reduces an amount of adhesive thermosetting resin, thus greatly reducing a volume proportion of the thermosetting resin in the rare earth permanent magnet, greatly enhancing the interaction between magnetic particles, and further achieving the purpose of enhancing the magnetization effect and magnetic performance of the final product. At the same time, due to the preheating temperature of the mold in the compression molding process and friction heating of contact points between particles under an extremely high pressure condition, chemically active epoxy groups of the resin harden and crosslink to form a network structure when curing conditions thereof reach at the microscopic level, thereby achieving the purpose of keeping high structural strength of clinker under a condition of low binder dosage.

In order to reduce friction among particles and friction between particles and the mold wall in the process of compressing magnetic powder complex particles under microscopic conditions, a lubricant suitable for powder compression is appropriately added while preparing the clinker, which is also beneficial to removing the green body from the mold smoothly.

Furthermore, in order to further improve a binding force between the thermosetting resin and surfaces of magnetic powder particles, a coupling agent including silane and/or titanate is added according to the type of resin. In order for better performance, it is preferable to use titanate as the coupling agent because titanate is helpful to form a uniform coating binder layer on the surfaces of magnetic powder particle so as to further optimize product performance. In order for higher strength, it is preferable to use silane as the coupling agent because silane is beneficial to reducing costs and also can form S-shaped cross structures on surfaces of magnetic powder particles, so as to increase structural strength of the product.

More preferably, the thermosetting resin and the coupling agent used in the preferred embodiment of the present invention are proposed to adopt commercially available W-6C/W-6D commercial bonded rare earth permanent magnet products which is suitable for epoxy resin and contains couple agent, that is, the ratio of the thermosetting resin to the coupling agent is about 3:1. Due to the large difference in the ratio of the coupling agent required by different types of thermosetting resins, it is necessary to select the best variety and determine the optimal ratio according to the specific application type.

Further, the lubricant includes graphite or stearate; graphite powder is a commonly used lubricant, and due to the conductivity of graphite powder, poor electrical conductivity of subsequent electrophoretic surface treatment caused by the increase of resistance among particles produced by resin envelopment is improved significantly; and when stearate is used as the lubricant, the stearate lubricant forms better binding force on the surfaces of the magnetic powder complex particles because both are organic compounds, and subsequent structural strength of the product is better; and preferably, the stearate includes zinc stearate and calcium stearate.

Preferably, raw materials have following mass percentages: the thermosetting resin 0.2-1.6 wt %, the lubricant 0.05-0.8 wt %, the coupling agent 0-1.0 wt %, and the balance being rare earth permanent magnetic powder, with which the mass percentages of the resin and the lubricant can be adjusted according to specific characteristics of products' structure and application.

Further, the rare earth permanent magnetic powder comprises at least one of rapidly quenched praseodymium and/or neodymium iron boron permanent magnetic powder, dysprosium-containing rapidly quenched neodymium iron boron permanent magnet powder, rapidly quenched lanthanum (cerium) iron-boron magnetic powder, HDDR permanent magnetic powder, samarium cobalt permanent magnetic powder, permanent magnet ferrite powder, samarium iron nitrogen permanent magnetic powder and neodymium-containing Fe₃B-based permanent magnet alloy powder.

Preferably, in order to improve coercive force performance of the magnet, when the magnetic powder is selected from rapidly quenched praseodymium and/or neodymium magnetic powder, it is preferable to use Dy/Tb—PrNd—Fe—B, Dy/Tb-Hx contained phase magnetic powder; similarly, when the magnetic powder is selected from rapidly quenched praseodymium and/or neodymium magnetic powder, modified powder containing any one or both of Co/Al—PrNd—Fe—B is preferred to improve temperature resistance of the magnet.

It should be noted that rapid quenched praseodymium and/or neodymium iron boron permanent magnetic powder is a product of rapidly quenched praseodymium and/or neodymium iron boron magnetic powder having a basic phase structure of R₂Fe₁₄B. The experiment involved in this application is proposed to use the commercially rapid quenched praseodymium and/or neodymium permanent magnetic powder or equivalent magnetic powder produced by Magquin Magnetic Company, which is collectively referred to as MQP permanent magnetic powder in the industry. That is, the rapid quenched permanent magnetic powder includes ordinary and conventional rapid quenched praseodymium and/or neodymium magnetic powder, rapid quenched lanthanum/cerium iron boron magnetic powder and rapid quenched praseodymium and/or neodymium magnetic powder; and HDDR permanent magnetic powder containing Dy/Tb—PrNd—Fe—B, Dy/Tb-Hx, Co/AI-PrNd—Fe—B;

HDDR permanent magnetic powder in the industry refers to the general name of neodymium iron boron magnetic powder with anisotropic characteristics prepared by the hydrogen cracking method.

The high-compactness bonded rare earth permanent magnet is prepared in accordance with following steps:
S1-mixing rare earth permanent magnetic powder after crystallization treatment with an organic solution in which the thermosetting resin and the coupling agent are dissolved to obtain a mixture, drying the mixture after sealing and stirring, and obtaining a magnetic powder complex after crushing;
further, the crystallization treatment takes place in a high-purity argon atmosphere at 670-730° C. for 10-20 min (preferably, at 690-710° C. for 13-18 min, the rare earth permanent magnetic powder after the crystallization treatment has a particle size of 80-120 mesh (preferably, 100 mesh).

Preferably, the crystallization treatment includes: coarsely crushing alloy strips after strip casting in an argon positive pressure environment, then loading obtained coarse particles into a crystallization furnace, and after pumping vacuum, crystalizing the coarse particles at a positive argon pressure of 0.3 at 670-730° C. for 10-20 min, cooling and crushing the crystalized particles to 80-120 mesh under the argon atmosphere, and obtaining powder.

More preferably, before the crystallization treatment, a step of rapid quenching and strip casting is further included, i.e., carrying out low-temperature protection and drying on alloy sheets which are subject to predetermined smelting, loading the alloy sheets into a vacuum melt spinning furnace, pumping vacuum, filling argon until a positive pressure is 0.1-0.5, and starting strip casting at a wheel speed of 20-23 m/s.

It should be noted that in this step, commercially available product powder can also be directly used to carry out S1, for example, MQP1-7 rapidly quenched neodymium iron boron commodity powder.

Further, the organic solution in which the thermosetting resin and the coupling agent are dissolved comprises an organic solvent such as acetone, chloroform, ethyl acetate, etc., preferably acetone.

Further, the sealing and stirring takes 40-60 min, preferably 45-55 min, so as to prevent the organic solvent from volatilizing too quickly during the stirring process and ensure that the thermosetting resin and magnetic particles are in full infiltration.

More preferably, the magnetic powder complex is prepared in accordance with following steps of:
dissolving 0.1-1.6 wt % of commercial thermosetting resins (e.g. W-6C or W-6D epoxy) in an acetone solution and mixing with crystalized rare earth permanent magnetic powder to obtain a mixture, sealing and stirring the mixture for 40-60 min, after mixing evenly, drying the mixture for 12-36 h until acetone is dried, crushing to 80-120 mesh by a wheel mixer and sieving.
S2—mixing the magnetic powder complex with the lubricant to obtain clinker; and
S3—filling the clinker into a mold at a temperature of 40-120° C. for preheating, compressing and molding, demolding to obtain a green body, heating the green body at 120-200° C. for 1-3 h to obtain a rough blank, and conducting precision machining on the rough blank.

The mold is preheated to a temperature of 40-120° C. (preferably 60-100° C.), mainly in view of a softening point of the thermosetting resin. When the temperature is higher than the softening point, the resin wrapped in the rare earth permanent magnetic powder particles softens, the fluidity and filling properties of the magnetic powder are further increased. For example, the softening point of W-6C or W-6D resin material is 60° C. (the temperature range chosen here is the empirical cumulative value); similarly, when a preset temperature is higher than 120° C., the resin becomes liquefied and adheres to the mold, thereby being hard to remove from the mold. Here, according to the different types of binders selected, the temperature range should be adjusted correspondingly.

Further, the compressing and molding takes place at a unit compressing force of 12-50 T/cm² for 0.3-10 s.

Further, in a preferable embodiment of the present invention, the green body has a density of 6.2-7.1 g/cm³, preferably 6.4-7.0 g/cm³. According to different unit compressing forces as well as different mold preheating temperatures, the green body presents different density states; in theory, the higher the density, the better the compressing and molding, but too high density will lead to difficulty in demolding. Therefore, the density of the green body here is controlled to be 6.2-7.1 g/cm³.

Further, the step of heating the green body to obtain the rough blank specifically comprises: heating the green body till an epoxy softening point thereof is reached, pumping vacuum till a pressure of environment is less than 0.2 atmospheres (or baking directly in a vacuum oven), keeping a temperature of environment at 120-200° C. for 2-3 h and then solidifying.

Specifically, in S3, the clinker is compressed, molded and demolded to form a green body of a desired geometric shape, comprising three stages: a compression stage, a compression maintaining and molding stage and a demolding stage, wherein

the compression stage refers to a process of compressing the clinker of a loose state into a desired geometry in a cavity of the mold. Since the magnetic powder particles have extremely high hardness and irregular shapes, when the clinker is filled into the cavity to form a loose clinker body and compressed up and down by the mold, with the loose clinker body being compressed continuously, friction between the magnetic powder particles and the wall of the cavity increases so that frictional forces on compression surfaces near the wall of the cavity and upper and lower pressing forces form shear forces. According to Bernoulli's law, a surface density of the clinker near the wall of the cavity is greater than density inside the blank, thereby forming compression stress from the outside to the inside of compressed clinker; most of pressing forces required are used to overcome friction forces among magnetic particles and friction forces between magnetic particles and the friction surfaces of the mold during the compression stage and the demolding stage, while maximum values of upper and lower pressing forces are reached and balance is achieved, both upper and lower parts of the mold stop compressing, at this time an internal friction force of the magnetic powder are equal to a total pressing force formed by upper and lower parts of the mold. After compression is maintained for a required time, powder of the clinker is compressed in a space constructed by a master form of the mold, the upper and lower parts of the mold and a mold core to form a compressed clinker of the magnet. In order to form a green body of the magnet as desired, it is necessary to complete the demolding stage next.

In this process, while molding, a unit pressing force of both the upper and lower parts is 17.0-50.0 T/cm², that is, an acting pressure is 1.7 GPa-5.0 Gpa. According to different particle sizes of the powder, the energies consumed for molding the clinker in the cavity from a loose state to a green body of required density vary greatly. Take the general regulation as an example, in the case of 100-mesh clinker, the experimental data shows that when the acting pressure is higher than 1.7 GPa, the density of the green body will reach 6.40 or more, and when the acting pressure is higher than 3.0 GPa, the density will reach 6.8 or more.
S4—painting a protective coating on surface thereof after conducting precision machining on the rough blank and the protective coating is prepared in at least one of following manners: applying antirust oil, electrophoresing, spraying epoxy, plating zinc, plating nickel, plating chrome, spraying plastics and coating parylene.

It should be noted that when the rare earth permanent magnetic powder comprises samarium cobalt permanent magnetic powder and permanent magnet ferrite powder, there is no need to prepare a protective coating because the material itself is not easy to be corroded. When other permanent magnetic powder is used, such as rapidly quenched neodymium iron boron magnetic powder and modified powder thereof containing dysprosium/terbium/cobalt/aluminum, rapidly quenched lanthanum iron boron powder, rapidly quenched cerium iron boron powder, HDDR permanent magnetic powder, samarium cobalt permanent magnetic powder, permanent magnet ferrite powder, samarium iron nitrogen permanent magnetic powder and neodymium-containing Fe₃B-based permanent magnet alloy powder, etc., a protective coating on the obtained permanent magnet is required to prevent corrosion of permanent magnet surface.

Specific embodiments of the present invention will be described in detail below. It should be understood that the specific embodiments described here are only used to illustrate and explain the present invention, and are not intended to limit the present invention.

### Embodiment 1

An embodiment of the present invention provides a high density bonded rare earth permanent magnet, a preparation method thereof includes:

(1) Powder preparation: using commercially available MQP1-7 rapidly quenched neodymium powder as rare earth permanent magnetic powder.

(2) Clinker preparation: dissolving 1.2 wt % of W-6C epoxy resin with acetone and mixing with crystalized rare earth permanent magnetic powder to obtain a mixture, sealing and stirring the mixture for 50 min, after mixing evenly, drying the mixture for 24 h until the acetone is dried, crushing to 100 mesh by a wheel mixer and sieving to obtain a magnetic powder complex, mixing the magnetic powder complex with 0.15 wt % of zinc stearate to obtain clinker for subsequent use.

(3) Product compression: preheating a mold to 60° C. through an oil guide groove built inside the mold and filling with the clinker, adjusting a preheating time of the clinker according to a size of a product, after fully preheating the clinker, compressing the clinker at an unit pressing force of 25 T/cm² for 5 s, demolding to obtain a green body of a density of 6.5 g/cm³ for subsequent use; placing the green body at 160° C. and keeping the temperature for 2.5 h, so as to solidify the green body to a final strength, and obtaining a rough blank of the product for subsequent use.

(4) Post-processing: after obtaining the rough blank of the product, according to requirements of a customer's drawings, conducting further machining such as grinding or wire cutting on the rough blank to obtain a fine blank of product, and coating the fine blank of product (spraying, electrophoresis, etc.) to make a semi-finished product, and conducting magnetization and packaging to produce a final magnetic part that meets the customer's needs.

### Embodiment 2

An embodiment of the present invention provides a high density bonded rare earth permanent magnet, a preparation method thereof includes:

(1) Powder preparation: using a commercially available MQP1-7 rapidly quenched neodymium powder as the rare earth permanent magnetic powder.

(2) Clinker preparation: dissolving 0.5 wt % of W-6D epoxy resin (containing a coupling agent) in acetone and mixing with crystalized rare earth permanent magnetic powder to obtain a mixture, sealing and stirring the mixture for 40 min, after mixing evenly, drying the mixture for 36 h until acetone is dried, crushing to 120 mesh by a wheel mixer and sieving to obtain a magnetic powder complex, and mixing the magnetic powder complex with 0.2 wt % of zinc stearate to obtain clinker for subsequent use.

(3) Product compression: preheating a mold to 120° C. through an oil guide groove built inside the mold and filling with the clinker, adjusting a preheating time of the clinker according to a size of a product, after fully preheating the clinker, compressing the clinker at an unit pressing force of 40 T/cm² for 0.3 s, demolding to obtain a green body of a density of 6.2 g/cm³ for subsequent use; placing the green body in a vacuum oven, heating to a temperature of 120° C. and keeping the temperature for 3 h, so that the green body cures and crosslinks in an approximate vacuum environment, and obtaining a rough blank of product with further improved density and performance.

(4) Post-processing: after obtaining the rough blank of product, according to requirements of a customer's drawings, conducting further machining such as grinding or wire cutting on the rough blank to obtain a fine blank of product, and coating the fine blank of product (spraying, electrophoresing, etc.) to make a semi-finished product, and conducting magnetization and packaging to produce a final magnetic part that meets the customer's needs.

### Embodiment 3

An embodiment of the present invention provides a high density bonded rare earth permanent magnet, a preparation method thereof includes:

(1) Powder preparation: using commercially available MQP1-7 rapidly quenched neodymium powder as rare earth permanent magnetic powder.

(2) Clinker preparation: dissolving 1.65 wt % of W-6C epoxy resin (containing a coupling agent) in acetone and mixing with crystalized rare earth permanent magnetic powder to obtain a mixture, sealing and stirring the mixture for 60 min, after mixing evenly, drying the mixture for 12 h until acetone is dried, crushing to 80 mesh by a wheel mixer and sieving to obtain a magnetic powder complex, mixing the magnetic powder complex with 0.05 wt % of zinc stearate to obtain clinker for subsequent use.

(3) Product compression: preheating a mold to 40° C. through an oil guide groove built into the mold and filling with the clinker, adjusting a preheating time of the clinker according to a size of a product, after fully preheating the clinker, compressing the clinker at an unit pressing force of 12 T/cm² for 10.0 s, demolding to obtain a green body of a density of 6.8 g/cm³ for subsequent use; placing the green body in an oven and heating to an epoxy softening point of the resin, reducing an air pressure in the oven to below 0.2 atmospheres, continuing heating to a temperature of 200° C. and keeping the temperature for 2 h, so that the product cures and crosslinks in an approximate vacuum environment, and obtaining a rough blank of product with further improved density and performance.

(4) Post-processing: after obtaining the rough blank of product, according to requirements of a customer's drawings, conducting further machining such as grinding or wire cutting on the rough blank to obtain a fine blank of product, and coating the fine blank of product (spraying, electrophoresing, etc.) to make a semi-finished product, and conducting magnetized packaging to produce a final magnetic part that meets the customer's needs.

In order to demonstrate that the rare earth permanent magnet provided in the present invention has high density and good magnetic performance, the following comparative experiments are carried out. In the following experiments, MQP1-7 commercial powder is used as the original powder for preparation and testing

### Experiment 1

Effects of contents of thermosetting resin on properties of rare earth permanent magnet

According to different contents of a thermosetting resin (W-6C epoxy resin) recorded in Table 1, the rare earth permanent magnets are prepared respectively by using the preparation method provided in Embodiment 1, and densities and BH properties of prepared products are tested, including Br (remanence), Hcb (coercivity), Hcj (intrinsic coercivity) and BHₘₐₓ (maximum magnetic energy product). And results are shown in Table 1.

TABLE 1
Effects of contents of thermosetting resin on
properties of the rare earth permanent magnet

| Thermo- | | | | | |
|---|---|---|---|---|---|
| setting | | | | | |
| resin | Density | BH Properties (25 T/cm²) | | | |
| (wt %) | (g/cm³) | Br(KG) | Hcb(KOe) | Hcj(KOe) | BHmax(MGOe) |
| 0.8 | 6.47 | 6.995 | 5.13 | 7.877 | 9.19 |
| 1.2 | 6.40 | 6.832 | 5.002 | 7.844 | 8.85 |
| 1.6 | 6.35 | 6.728 | 4.988 | 7.834 | 8.59 |
| 2.0 | 6.22 | 6.52 | 4.909 | 7.909 | 8.26 |
| 4.0 | 5.93 | 6.157 | 4.794 | 8.123 | 7.56 |

### Experiment 2

Effects of contents of lubricants on properties of the rare earth permanent magnet

According to different contents of a lubricant (zinc stearate) recorded in Table 2, rare earth permanent magnets are prepared respectively by using the preparation method provided in Embodiment 1, and densities and BH properties of prepared products are tested, including Br (remanence), Hcb (coercivity), Hcj (intrinsic coercivity) and BHₘₐₓ (maximum magnetic energy product). The results are shown in Table 2.

TABLE 2
Effects of contents of lubricant on properties
of rare earth permanent magnet

| Lubricant | Density | BH Properties(25 T/cm²) | | | |
|---|---|---|---|---|---|
| (wt %) | (g/cm³) | Br(KG) | Hcb(KOe) | Hcj(KOe) | BHₘₐₓ(MGOe) |
| 0.05 | 6.122 | 6.567 | 4.94 | 7.853 | 8.22 |
| 0.1 | 6.368 | 6.731 | 4.696 | 7.775 | 8.61 |
| 0.15 | 6.402 | 6.755 | 5.012 | 7.832 | 8.82 |
| 0.2 | 6.368 | 6.743 | 4.979 | 7.783 | 8.61 |
| 0.3 | 6.352 | 6.728 | 4.988 | 7.834 | 8.59 |

### Experiment 3

Effects of unit pressing forces on properties of the rare earth permanent magnet

According to different unit pressing forces recorded in Table 3 for compressing the clinker, rare earth permanent magnets are prepared by using the preparation method provided in Embodiment 1 respectively, and densities and BH properties of prepared products are tested, including Br (remanence), Hcb (coercivity), Hcj (intrinsic coercivity) and BHₘₐₓ (maximum magnetic energy product). The results are shown in Table 3.

TABLE 3
Effects of unit pressing force on properties
of rare earth permanent magnet

| Unit | | | | | |
|---|---|---|---|---|---|
| pressing | | | | | |
| force | Density | BH Properties(25 T/cm²) | | | |
| (T/cm²) | (g/cm³) | Br(KG) | Hcb(KOe) | Hcj(KOe) | BHₘₐₓ(MGOe) |
| 10 | 6.07 | 6.413 | 4.881 | 7.803 | 8.03 |
| 12 | 6.15 | 6.502 | 4.937 | 7.87 | 8.24 |
| 15 | 6.194 | 6.58 | 4.993 | 7.849 | 8.47 |
| 18 | 6.24 | 6.632 | 5.021 | 7.856 | 8.62 |
| 22 | 6.271 | 6.656 | 5.034 | 7.911 | 8.64 |

### Experiment 4: Effects of Compression Temperatures on Properties of the Rare Earth Permanent Magnet

According to different compression temperatures for compressing clinker recorded in Table 4, rare earth permanent magnets are prepared by using the preparation method provided in Embodiment 1 respectively, and densities and BH properties of prepared products are tested, including Br (remanence), Hcb (coercivity), Hcj (intrinsic coercivity) and BHₘₐₓ (maximum magnetic energy product). The results are shown in Table 4.

TABLE 4
Effects of compression temperatures on properties
of the rare earth permanent magnet

| Compression | | | | | |
|---|---|---|---|---|---|
| temperature | Density | BH Properties (25 T/cm²) | | | |
| (° C.) | (g/cm³) | Br(KG) | Hcb(KOe) | Hcj(KOe) | BHₘₐₓ(MGOe) |
| 20 | 6.194 | 6.58 | 4.993 | 7.849 | 8.47 |
| 45 | 6.36 | 6.687 | 5.143 | 7.813 | 8.79 |
| 60 | 6.442 | 6.785 | 5.079 | 7.619 | 8.89 |

Finally, it should be noted that the above are only some preferred embodiments of the present invention and are not intended to limit the scope of protection of the present invention. Any modification, equivalent substitution, improvement, etc. made within the spirit and principles of the present invention shall be included in the scope of protection of the present invention.

1. A method for preparing a high-compactness bonded rare earth permanent magnet, wherein,
raw materials of the high-compactness bonded rare earth permanent magnet calculated by a mass percentage comprise: thermosetting resin 0.1˜1.6 wt %, a lubricant 0.05˜0.8 wt %, a coupling agent 0˜1.0 wt %, and the balance being rare earth permanent magnetic powder; and
the method comprises:
mixing the rare earth permanent magnetic powder after crystallization treatment with a solution in which the thermosetting resin and the coupling agent are dissolved to obtain a mixture, drying the mixture after sealing and stirring, and obtaining a magnetic powder complex after crushing;
mixing the magnetic powder complex with the lubricant to obtain clinker; and
filling the clinker into a mold at a temperature of 40˜120° C. for preheating, compressing and molding, demolding to obtain a green body, heating the green body at 120˜200° C. for 1˜3 h to obtain a rough blank, and conducting precision machining on the rough blank.

2. The method for preparing the high-compactness bonded rare earth permanent magnet according to claim 1, wherein, the rare earth permanent magnetic powder comprises at least one of rapidly quenched praseodymium and/or neodymium iron boron magnetic powder and modified powder thereof containing dysprosium/terbium/cobalt/aluminum, rapidly quenched lanthanum iron boron powder, rapidly quenched cerium iron boron powder, HDDR permanent magnetic powder, samarium cobalt permanent magnetic powder, permanent magnet ferrite powder, samarium iron nitrogen permanent magnetic powder and neodymium-containing Fe₃B-based permanent magnet alloy powder.

3. The method for preparing the high-compactness bonded rare earth permanent magnet according to claim 1, wherein, the lubricant comprises graphite and/or stearic acid and stearate; and the stearate comprises zinc stearate and/or calcium stearate.

4. The method for preparing the high-compactness bonded rare earth permanent magnet according to claim 1, wherein, the crystallization treatment takes place at 670˜730° C. for 10˜20 min in an argon atmosphere.

5. The method for preparing the high-compactness bonded rare earth permanent magnet according to claim 1, wherein, the rare earth permanent magnetic powder after crystallization treatment has a particle size of 60˜200 meshes.

6. The method for preparing the high-compactness bonded rare earth permanent magnet according to claim 1, wherein sealing and stirring takes 40˜60 min while preparing the magnetic powder complex.

7. The method for preparing the high-compactness bonded rare earth permanent magnet according to claim 1, wherein the green body has a density of 6.2˜7.1 g/cm³; and compressing and molding takes place at an unit compressing force of 12-50 T/cm² for 0.3˜10 s.

8. The method for preparing the high-compactness bonded rare earth permanent magnet according to claim 1, wherein the step of heating the green body to obtain the rough blank specifically comprises: heating the green body till an epoxy softening point thereof is reached, vacuumizing till a pressure of environment is less than 0.2 atmosphere, and keeping temperature of environment at 120˜200° C. for 2˜3 h.

9. The method for preparing the high-compactness bonded rare earth permanent magnet according to claim 1, further comprising a step of painting a protective coating on the rough blank after machining; and the protective coating is prepared in at least one of following manners: applying antirust oil, electrophoresing, spraying epoxy, plating zinc, plating nickel, plating chrome, spraying plastics and coating parylene.

10. A high-compactness bonded rare earth permanent magnet, wherein the high-compactness bonded rare earth permanent magnet has a density of 6.2-7.0 g/cm³;
wherein raw materials of the high-compactness bonded rare earth permanent magnet calculated by a mass percentage comprise: thermosetting resin 0.1-1.6 wt %, a lubricant 0.05-0.8 wt %, a coupling agent 0-1.0 wt %, and the balance being rare earth permanent magnetic powder; and
a method for preparing the high-compactness bonded rare earth permanent magnet comprises:
mixing the rare earth permanent magnetic powder after crystallization treatment with a solution in which the thermosetting resin and the coupling agent are dissolved to obtain a mixture, drying the mixture after sealing and stirring, and obtaining a magnetic powder complex after crushing;
mixing the magnetic powder complex with the lubricant to obtain clinker; and
filling the clinker into a mold at a temperature of 40-120° C. for preheating, compressing and molding, demolding to obtain a green body, heating the green body at 120-200° C. for 1-3 h to obtain a rough blank, and conducting precision machining on the rough blank;
wherein, the green body has a density of 6.2-7.1 g/cm³; and compressing and molding take place at a unit compressing force of 12-50 T/cm² for 0.3-10 s.

11. The high-compactness bonded rare earth permanent magnet according to claim 10, wherein the rare earth permanent magnetic powder comprises at least one of rapidly quenched praseodymium and/or neodymium iron boron magnetic powder and modified powder thereof containing dysprosium/terbium/cobalt/aluminum, rapidly quenched lanthanum iron boron powder, rapidly quenched cerium iron boron powder, HDDR permanent magnetic powder, samarium cobalt permanent magnetic powder, permanent magnet ferrite powder, samarium iron nitrogen permanent magnetic powder and neodymium-containing Fe₃B-based permanent magnet alloy powder.

12. The high-compactness bonded rare earth permanent magnet according to claim 10, wherein, the lubricant comprises graphite and/or stearic acid and stearate; and the stearate comprises zinc stearate and/or calcium stearate.

13. The high-compactness bonded rare earth permanent magnet according to claim 10, wherein, the crystallization treatment takes place at 670-730° C. for 10-20 min in an argon atmosphere.

14. The high-compactness bonded rare earth permanent magnet according to claim 10, wherein the rare earth permanent magnetic powder after crystallization treatment has a particle size of 60-200 meshes.

15. The high-compactness bonded rare earth permanent magnet according to claim 10, wherein sealing and stirring takes 40-60 min while preparing the magnetic powder complex.

16. (canceled)

17. The high-compactness bonded rare earth permanent magnet according to claim 10, wherein the step of heating the green body to obtain the rough blank comprises: heating the green body till an epoxy softening point thereof is reached, vacuumizing till a pressure of environment is less than 0.2 atmosphere, and keeping a temperature of an environment at 120-200° C. for 2-3 h.

18. The high-compactness bonded rare earth permanent magnet according to claim 10, further comprising a step of painting a protective coating on the rough blank after machining; and the protective coating is prepared in at least one of following manners: applying antirust oil, electrophoresing, spraying epoxy, plating zinc, plating nickel, plating chrome, spraying plastics and coating parylene.
